(19) United States
(12) Patent Application Publication
(10) Pub. No.: US 2009/0271768 A1
(43) Pub. Date: Oct. 29, 2009

(54) DISCRIMINATING PROGRAM CODE UPDATES AFTER MERGING FOR LIVE REVIEW

(75) Inventor: Kelvin Goodson, Winchester (GB)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/109,107

(22) Filed: Apr. 24, 2008

(51) Int. Cl. G06F 9/44

(52) U.S. Cl. 717/125

(57) ABSTRACT

A method for dynamically discriminating a program code patch update after merging a patch file into unmodified source code for dynamic review. The method includes providing a graphical user interface (GUI) to enable a user to merge a source code patch file into an existing, pre-modified version of source code to generate a variant form of the existing, pre-modified source code and binary artifacts, via the GUI, presenting a display image highlighting differences between existing, pre-modified source code and the variant form after merging the source code patch file into the existing, pre-modified source code, via the GUI, presenting the user with an option of debugging the existing, pre-modified version of the source code, the GUI presenting linked views highlighting the existing, pre-modified version of the source code with the variant form of the source code, in parallel, debugging the variant form of the source code, the GUI presenting linked views highlighting the existing, pre-modified version with the variant form of the source code, in parallel and debugging both the existing, pre-modified version of the source code and the variant form of the source code, in parallel, while stepping through the existing, pre-modified and variant forms of the source code synchronously, while the GUI presents the linked views.

### BACKGROUND OF THE INVENTION

In software development, and particularly in open source software development, a subset of developers has write access to the source code. Those without write access submit “patch files” for review, and potential inclusion into the source code by persons with write access. The source code modified by inclusion of the patch is referred to as a patch update. The review process is often cyclic, requiring the patch file submitter to perform additional work before the patch file is ready for integration into the shared source code base.

The patch files carry the differences to the source code that must be implemented by the person with write access. Tools exist for the patch file reviewer with write access to readily review the nature of the patch update. For example, a viewer assesses the updated representation of the source code into which the patch filed is integrated, i.e., the patch update, side by side with the unmodified source code. The proposed modifications comprising the patch file are highlighted using colors to distinguish the nature of the modifications. Views presented by known techniques for viewing and assessing a software patch file after incorporation into an unmodified version of the source code are referred to herein as static views.

A complex software update, however, may prove difficult to thoroughly review in this static fashion, i.e., via a static review. The quality of the patch update can at times be fully revealed only after detailed review while exercising the updated code with the integrated patch file. Currently, such a static review requires integration of the patch code (file) into the reviewer's development environment. After integration, however, distinctions between the unmodified version and the updated version (i.e. the patch update), when viewed using conventional integrated development environments (IDEs) are far harder to observe. Conventional IDEs are not known to preserve and effectively communicate to the software developer differences between the unmodified source code, and the source code modified with the patch file, i.e., the patch update.

### SUMMARY OF THE INVENTION

To that end, the invention overcomes the shortcomings of the prior art integrated development environments by providing a tool for dynamically discriminating program code updates after merging a patch file into source code, and preserving and conveying the change information later into the software development lifecycle. The inventive tool permits a dynamic appraisal of proposed patch updates via a novel graphical user interface (GUI).

The invention retains the change information contained in a patch update after the patch code (file) is integrated into the reviewer's existing (current) code. The GUI presents the change information for review in a novel visual debugging environment that dynamically conveys the difference information, meaning the differences between the patch update and the unmodified source code. As mentioned, conventional IDE debugging environments provide only static views of source code updated with a patch file.

In a preferred form, the invention includes a method for dynamically discriminating a program code patch update after merging a patch file into unmodified source code for dynamic review. The method includes providing a graphical user interface (GUI) to enable a user to merge a source code patch file into an existing, pre-modified version of source code to generate a variant form of the existing, pre-modified source code and binary artifacts, and, via the GUI, presenting a display image highlighting differences between existing, pre-modified source code and the variant form after merging the source code patch file into the existing, pre-modified source code. The method further includes that, via the GUI, presenting the user with an option of debugging the existing, pre-modified version of the source code, the GUI presenting linked views highlighting the existing, pre-modified version of the source code with the variant form of the source code, in parallel, debugging the variant form of the source code, the GUI presenting linked views highlighting the existing, pre-modified version with the variant form of the source code, in parallel and debugging both the existing, pre-modified version of the source code and the variant form of the source code in parallel while stepping through the existing, pre-modified and variant forms of the source code synchronously, while the GUI presents the linked views.

### BRIEF DESCRIPTION OF THE DRAWING FIGURES

The foregoing and other objects, aspects and advantages will be better understood from the following detailed description of embodiments of the inventions, with reference to the drawings, in which:

FIG. 1 is a representation of a general purpose computer system into which is provided a set of computer-readable instructions for implementing the inventive method for discriminating program code updates after merging for a live review; and

FIG. 2 is a schematic flow diagram depicting one embodiment of the method for discriminating program code updates after merging for a live review.

### DETAILED DESCRIPTION OF THE INVENTION

The present invention includes a computer-based method, or tool, for use in an integrated development environment (IDE) that integrates a patch file into a current version of source code to realize variant forms of the affected source code (i.e., patch updates that comprise the source code as modified by patch file integration). The invention presents the two variant forms of the affected source code, i.e., before and after the patch updates, through a graphical user interface (GUI), which variant forms highlight the changes to the current (unmodified) version of the source codes The invention provides an extra review phase, introduced between the known static review, and the known fill patch integration. For example, the GUI allows the user to choose whether to: 1) debug the unmodified source code while presenting a linked view highlighting the unmodified source code and the corresponding modified source code comprising the patch update, in parallel; 2) debug the modified source code while presenting a linked view highlighting the unmodified source code and the corresponding modified source code comprising the patch update, in parallel; and 3) debug the unmodified source code and the modified source code comprising the patch update in parallel, keeping the parallel executions in synchronization, while displaying the unmodified and updated source in linked views with the debugger through steps via the GUI.

The various method embodiments of the invention will be generally implemented by a computer executing a sequence of program instructions for carrying out the steps of the method, assuming all required data for processing is accessible to the computer. The sequence of program instructions may be embodied in a computer program product comprising media storing the program instructions.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the method, and variations on the method as described herein. Alternatively, a specific use computer, containing specialized hardware for carrying out one or more of the functional tasks of the invention, could be utilized.

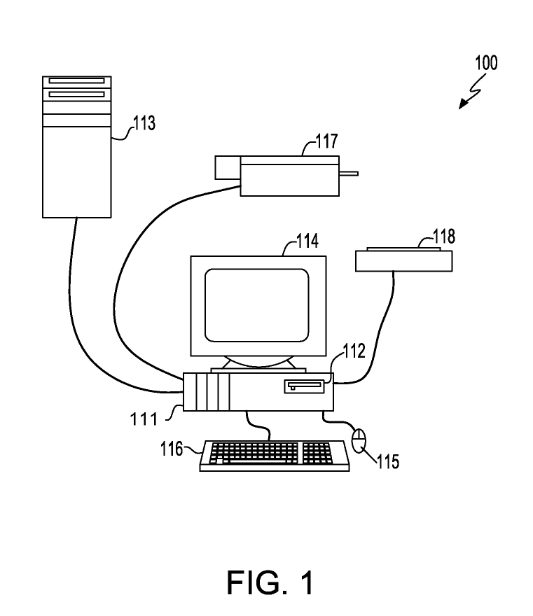

A computer-based system (100) is depicted in FIG. 1 herein by which the method of the present invention maybe carried out. Computer-based system (100) includes a processing unit (1 10), which houses a processor, memory and other systems components (not shown expressly in the drawing figure) that implement a general purpose processing system, or computer that may execute a computer program product. The computer program product may comprise media, for example a compact storage medium such as a compact disc, which may be read by the processing unit (110) through a disc drive (120), or by any means known to the skilled artisan for providing the computer program product to the general purpose processing system for execution thereby.

The computer program product comprises all the respective features enabling the implementation of the methods described herein, and which—when loaded in a computer system—is able to carry out these methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit (110), as mentioned, or may be located on a remote system such as a server (130), coupled to processing unit (110), via a network interface such as an Ethernet interface. Monitor (140), mouse (150) and keyboard (160) are coupled to the processing unit (110), to provide user interaction. Scanner (170) and printer (180) are provided for document input and output. Printer (180) is shown coupled to the processing unit (110) via a network connection, but may be coupled directly to the processing unit. Scanner (170) is shown coupled to the processing unit (110) directly, but it should be understood that peripherals might be network coupled, or direct coupled without affecting the ability of the processing unit (110) to perform the method of the invention.

The novel method, or integrated development environment (IDE) tool and graphical user interface enables the user to create and view an updated version of the source code, preserving an ability to roll back the patch updates if the modifications with the integrated patch files are deemed unsuitable. The execution of the updated code, i.e., the patch update, is controlled by normal debugger functions via the GUI while the unmodified code (before modification by the patch file) is optionally displayed side by side with the updated code.

To further increase the readability of the proposed patch update (source code with modification), the GUI display images highlight the modifications using coloring in a way similar to highlighting implemented with existing tools that permit static review of patch updates. But in addition, the invention provides for two (debugging) executions in parallel, which are presented for viewing via the GUI, where one execution uses the unmodified code and one execution uses the updated code. Such a dynamic presentation permits the reviewer to more readily investigate the update to a finer detail than is available using known IDE tools.

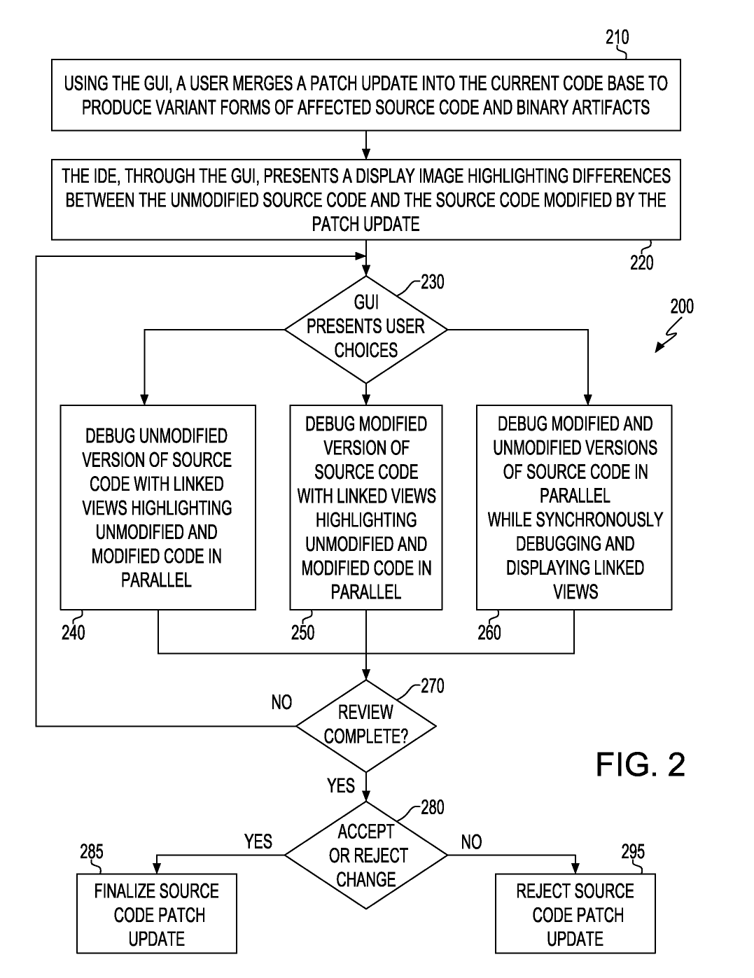

FIG. 2 is a schematic flow diagram depicting one embodiment of the method (200) for dynamically discriminating a program code patch update after merging a patch file into pre-modified source code via live or real-time review. In a step (210), using the GUI provided by the novel IDE tool, a user merges a patch file into the current (unmodified) version to produce variant forms of the affected source code and binary artifacts. In a step (220), the IDE utilizes the GUI to present a display image highlighting differences between unmodified source code and the modified source code after integration with the patch file, i.e., the patch update. In a decision step (230), a reviewer (used interchangeably herein with “user”) chooses one of several debug functions (three (3) of which are shown in the exemplary embodiment of FIG. 2) having particular GUI views.

Step (240) is executed when the reviewer chooses to debug the unmodified version of the source code, and the GUI presents linked views highlighting the modified and unmodified versions of the code in parallel. Step (250) is executed when the reviewer chooses to debug the modified version of the source code (updated with the patch file), and the GUI presents linked views highlighting the modified and unmodified versions of the code in parallel. Step (260) is executed when the reviewer chooses to debug both the modified and unmodified versions of the source code in parallel, where in coordination with the GUI, the novel IDE tool executes or steps through the two versions synchronously while the GUI presents the linked views. Each of steps (240), (250) and (260) proceed to a step (270), where the user determines whether the review is complete.

If the review is incomplete, the user inputs same via the GUI and the program flow progresses to step (230). If review is complete, the program flow progresses to a decision step (280), where the user must decide whether to accept or reject the source code patch update. If yes, program flow progresses to step (285), whereby the novel IDE finalizes the source code patch update. If no, program flow progresses to step (295), rejecting the source code patch update.

Although a few examples of the present invention have been shown and described, it would be appreciated by those skilled in the art that changes might be made in these embodiments without departing from the principles and spirit of the invention, the scope of which is defined in the claims and their equivalents.

1. A method for dynamically discriminating a program code patch update after merging a patch file into unmodified source code for dynamic review, comprising the steps of:
providing a graphical user interface (GUI) to enable a user to merge a source code patch file into an existing, pre-modified version of source code to generate a variant form of the existing, pre-modified source code and binary artifacts;
via the GUI, presenting a display image highlighting differences between existing, pre-modified source code and the variant form after merging the source code patch file into the existing, pre-modified source code;
via the GUI, presenting the user with a debugging option selected from:
debugging the existing, pre-modified version of the source code, the GUI presenting linked views highlighting the differences between the existing, pre-modified version of the source code and the variant form of the source code in parallel;
debugging the variant form of the source code, the GUI presenting linked views highlighting the differences between the existing, pre-modified version and the variant form of the source code in parallel; and
synchronously debugging the existing, pre-modified version of the source code and the variant form of the source code in parallel, while stepping through the existing, pre-modified and variant forms of the source code, the GUI presenting the linked views, and
determining whether to accept the source code patch file according to a result of the selected debugging option, wherein,
if the source code patch file is accepted, finalizing a source code patch file update, and
if the source code patch file is not accented, rejecting the source code patch file update.

2. A tool for use in an integrated development environment (IDE) comprising a computer program product, the computer program product, comprising:
a tangible storage medium readable by a processing circuit and storing instructions for execution by the processing circuit for performing a method as set forth in claim 1.
